(19) United States
(12) Patent Application Publication
(10) Pub. No.: US 2006/0250564 A1
(43) Pub. Date: Nov. 9, 2006

(54) Laminate bonding by ambient pressure differential

(76) Inventor: Dean Eshleman, Streetsboro, OH (US)

Correspondence Address: ROETZEL & ANDRESS, 1375 EAST 9TH STREET, CLEVELAND, OH, 44114, US

(21) Appl. No.: 11/124,713

(22) Filed: May 9, 2005

(51) Int. Cl. B32B 37/00

(52) U.S. Cl. 349/153; 156/145; 156/292; 156/285; 349/190

(57) ABSTRACT

A laminate, and a method of forming a laminate that includes a first substrate coupled to a second substrate to define a cavity having a predetermined cell gap, and a continuous seal disposed between the substrates that extends about the entire periphery of the laminate and is substantially devoid of apertures. The substrates are joined together by a peripheral seal in a relatively low pressure environment and then relocated to a relatively higher pressure environment to establish a cell gap between the substrates by the relative change in ambient pressure.

### FIELD OF THE INVENTION

The invention relates generally to laminate structures comprising at least two substrates, and more particularly to a method of forming a laminate structure comprising a complete peripheral seal between at least two substrates.

### BACKGROUND OF THE INVENTION

Conventional laminate-forming methods have typically required two or more substrates to be bonded together with a seal provided about the perimeter of the combined substrates. Such methods required material that would form the seal to be applied about the entire perimeter of one substrate with the exception of at least one segment that was to form a gap in the seal. The gap in the seal was necessary to enable evacuation of the cavity between the two substrates once they were mated together.

A gap 13 left in the perimeter seal 14 of the laminate by the conventional methods is shown in FIG. 1. Until now, it was generally accepted that this gap 13 was necessary to allow evacuation of the cavity between the substrates to form a vacuum therein and draw the substrates together as desired to regulate the distance between the two substrates, commonly referred to as the cell gap. The substrates were typically mated together by the seal material and then placed within a vacuum bag, which was used to remove the air from within the cavity through the gap 13 in the perimeter seal 14. Once the desired cell gap was achieved, the perimeter seal 14 was allowed to cure and the laminate removed from the vacuum bag. The gap 13 in the perimeter seal 14 then had to be plugged before the laminate could be diced, which introduced an opportunity for the laminate to be damaged and made the laminate-assembly method complicated.

Other laminate-assembly methods included the use of a mechanical press, in addition to the vacuum bag, to force the substrates toward each other and minimize relaxation of the bond between the two substrates that would cause enlargement of the cell gap. Again, once compression was complete and the desired cell gap was achieved, the opening in the perimeter seal 14 had to be sealed. Just as before, sealing the gap 13 in the perimeter seal 14 and the impact of the mechanical press could inflict damage to the laminate, and the combination of processes further added to the complexity of the assembly process.

Accordingly, there is a need in the art for a laminate-assembly method that can achieve a desired cell gap. The assembly method should be simple, and should minimize the number of opportunities for introducing defects to the laminate. Further, the method should provide for a laminate having a substantially-complete seal about its perimeter that does not require post-assembly plugging to enhance the integrity of the perimeter seal.

### SUMMARY OF THE INVENTION

It is an object of the present invention to provide a laminate having a complete perimeter seal that extends entirely about the perimeter of the laminate without interruption. It is a further object of the present invention to provide a laminate-assembly method that minimizes the complexity of assembling a laminate.

In accordance with one aspect, the present invention achieves these and other objects by providing a method of fabricating a laminate structure. The method comprises the steps of applying a seal material to at least one of a first substrate and a second substrate; coupling the first substrate to the second substrate with the seal material disposed between the first and second substrates, thereby forming a cavity between the first and second substrates and a generally continuous and uninterrupted seal about the entire periphery of the laminate when the first and; and creating a low-pressure within the cavity relative to the pressure outside of the cavity to force the first and second substrates together and establish a desired cell gap.

In accordance with another aspect, the present invention achieves these and other objects by providing a method of fabricating a laminate structure. The method comprises the steps of applying a seal material to at least one of a first substrate and a second substrate in a pattern that forms a seal about the entire periphery of the laminate structure when the first substrate is coupled to the second substrate. The first and second substrates are exposed to a low-pressure environment having a lower pressure than an ambient environment to which the laminate structure will be returned following exposure to the low-pressure environment. The first substrate is coupled to the second substrate on opposite sides of the seal material in the low-pressure environment to form the seal and a cavity between the first and second substrates. The coupled first and second substrates is exposed to the ambient environment having a higher pressure than the low-pressure environment, and a desired cell gap is established.

In accordance with yet another aspect, the present invention achieves these and other objects by also providing a method of fabricating a laminate structure. The method comprises the steps of applying a seal material to at least one of a first substrate and a second substrate in a pattern that forms a seal about the entire periphery of the laminate structure when the first substrate is coupled to the second substrate; and coupling the first substrate to the second substrate on opposite sides of the seal material in an environment having a first pressure, thereby forming the seal and a cavity between the first and second substrates. The coupled first and second substrates are exposed to a low-pressure environment having a second pressure that is lower than the first pressure, then exposed to an environment having a higher pressure than the pressure in the low-pressure environment to establish a desired cell gap.

In accordance with yet another aspect, the present invention achieves these and other objects by also providing a laminate produced according to a method comprising the steps of applying seal material entirely about a periphery of a first substrate; placing the first substrate and a second substrate in a vacuum chamber; evacuating the vacuum chamber to establish a sub-atmospheric low-pressure environment; coupling the first substrate to the second substrate on opposite sides of the seal material in the low-pressure environment, thereby forming the seal and a cavity between the first and second substrates; exposing the coupled first and second substrates to an atmospheric-pressure ambient environment; and establishing a desired cell gap.

In accordance with yet another aspect, the present invention achieves these and other objects by also providing a laminate comprising a first substrate coupled to a second substrate, wherein the first and second substrates define a cavity having a predetermined cell gap; and a continuous seal disposed between the substrates that extends about the entire periphery of the laminate and is substantially devoid of apertures formed during fabrication to allow access to the cavity.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a laminate structure having a conventional perimeter seal that includes an aperture through which an internal cavity between two substrates can be accessed;

FIG. 2 is a cross-sectional view of a laminate in accordance with one aspect of the present invention adapted for liquid-crystal display applications;

FIG. 3 is a top view of a laminate in accordance with an aspect of the present invention with the perimeter seal shown using hidden lines;

FIG. 4 is an illustrative arrangement of individual laminate dies to be cut from a laminate in accordance with an aspect of the present invention;

FIG. 5 is a flow diagram illustrating an embodiment of a method according to the present invention; and

FIG. 6 is a flow diagram illustrating another embodiment of a method according to the present invention.

### DETAILED DESCRIPTIONS OF PREFERRED AND ALTERNATE EMBODIMENTS

Certain terminology is used herein for convenience only and is not to be taken as a limitation on the present invention. Further, in the drawings, certain features may be shown in somewhat schematic form.

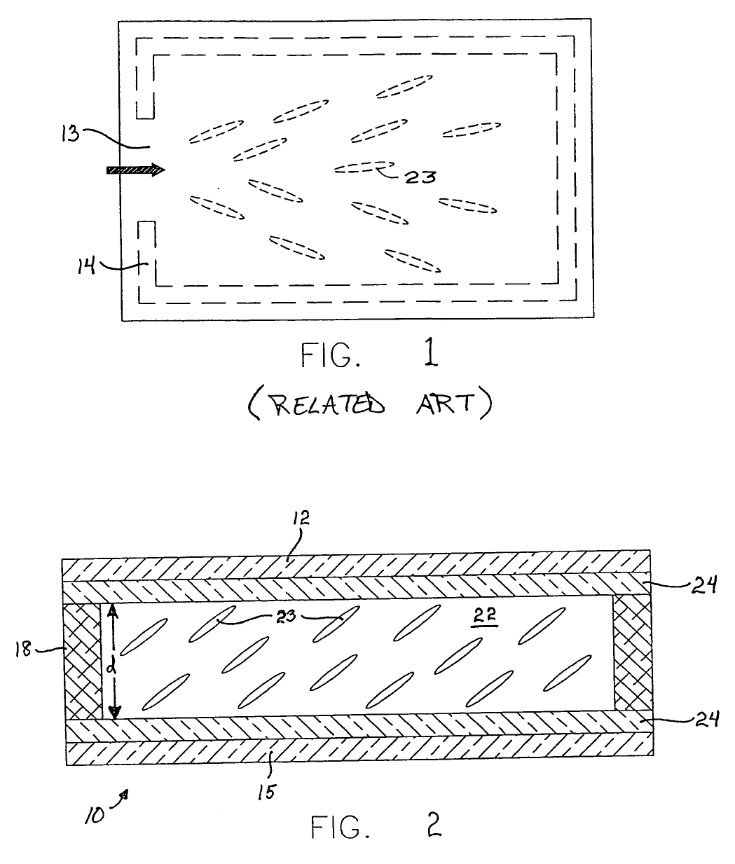

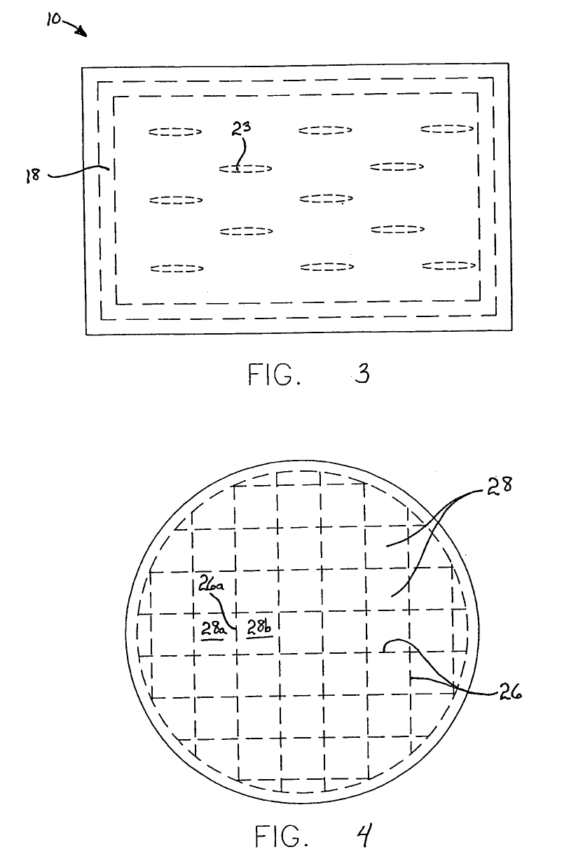

FIG. 1 illustrates a bonded-laminate structure (“laminate”) 10 according to an embodiment of the present invention. As shown, the laminate 10 includes a first substrate 12 coupled to a second substrate 15 by a seal 18. The seal 18 is uninterrupted and continuous about the entire periphery of the laminate 10, meaning that it is substantially devoid of patches, plugs and other measures used to seal an aperture formed in the seal during fabrication, for example. The patches, plugs, and other measures have traditionally been applied as a post-fabrication step to hermetically seal a cavity 22 formed between the two substrates 12, 15 only after a majority of the seal was formed between the two substrates 12, 15 and the desired cell gap d was obtained. The laminate 10 can optionally also include electric circuitry, including conductors such as vias, layered switching devices, and insulating layers; liquid-crystal molecules 23 disposed between the substrates 12, 15; an alignment layer 24 to direct the orientation of liquid-crystal molecules 23; and the like.

The material that will form the seal 18 can be any viscous fluid when it is applied to one or both of the substrates 12, 15, that can be cured or otherwise solidified to an extant such that the seal 18 generally retains its shape to maintain the desired cell gap d between the substrates 12, 15, once the cell gap d is established. However, other embodiments include a seal 18 formed from single-piece rubberized materials, amorphous materials, solid materials, and the like. A gasket is one example of a suitable seal 18 between two substrates 12, 15. Specific examples of suitable seal materials include, but are not limited to, plastics and any other non-porous material that air can not pass through under typical pressures that the laminate will be subjected to.

The seal 18 is uninterrupted and continuous about the entire periphery of the laminate 10, and lacks a preformed aperture dedicated to forming a vacuum within the cavity 22 between the substrates 12, 15. Defined as such, the seal 18 is generally intact and continuous when it is established between the substrates 12, 15, regardless of the laminate's 10 method of manufacture, and does not include an aperture therein dedicated to allowing access to the cavity 22 between the substrates 12, 15. This definition encompasses a generally-linear seal 18 that is positioned about the periphery of a substrate 12, 15 such that a tail end of the seal 18 is placed adjacent to a beginning of the seal 18, in a so called tip-to-tail arrangement. This definition also includes a seal formed by applying a bead of a fluid material about, and optionally inward of the periphery of one or more substrates 12, 15 to establish a complete seal 18 about the laminate 10 and any individual laminate dies 28 (FIG. 4). Thus, an aperture in the seal 18 is not required to evacuate the cavity 25 between the substrates 12, 15 in a vacuum assembly method, for example.

Although the seal 18 is described above as being positioned about the periphery of the laminate 10, other embodiments of the present invention further include one or more seals 26 arranged inward of the laminate's 10 periphery to form individual laminate dies 28. As illustrated in FIG. 4, individual laminate dies 28 can be partitioned from a laminate 10 comprising two circular substrates 12, 15. Circular substrates are common in applications such as integrated-circuit fabrication where the substrate is formed from single-crystal silicon. Such single-crystal silicon substrates are typically cut from a cylindrical ingot of single-crystal material that is drawn from a bath of polysilicon.

Similar to the laminate 10, each individual laminate die 28 includes an internal cavity 22 between the substrates 12, 15 that is sealed by inward seals 26, which are illustrated as hidden lines in FIG. 4. Neighboring individual laminate dies 28a and 28b will include a common inward seal 26a that separates the cavity 22 of one individual laminate die 28a from the cavity 27 of its neighboring individual laminate die 28b. When the individual laminate dies 28 are cut from the laminate 10, a process commonly referred to as dicing, cuts are made longitudinally along the inward seals 26 to separate the individual laminate dies 28 from the laminate 10. Once the neighboring individual laminate dies 28a, 28b are separated from each other during dicing, a portion of the common inward seal 26a that once divided neighboring dies 28a, 28b forms a perimeter seal of each neighboring laminate die 28a, 28b.

Additional embodiments of the present invention optionally include spacers (not shown) positioned between the substrates 12, 15 of the laminate 10 to maintain a suitable cell gap between the substrates 12, 15. A vacuum can be created between the substrates to achieve the desired cell gap, a process which is described in detail below. Spacers can also optionally be used to prevent the substrates 12, 15 from bowing inward under the force of the vacuum between the substrates 12, 15 and contacting each other at central regions between seals 18, 26. Examples of suitable spacers include solid spherical particles having a diameter similar to the desired cell gap d, the material used to form the seal, and any other physical object that can be disposed between the substrates 12, 15 to maintain the desired cell gap d without interfering with the intended function of the laminate 10.

The substrates 12, 15 can be any substrate commonly used in the manufacture of liquid-crystal cells, integrated circuits, but can also be any two substrates that are to be bonded together to form a laminate 10. Glass and silicon substrates are examples of those used in liquid-crystal cell applications, but other substrates that can be bonded together to form the laminate of the present invention include plastics, plastic compositions, metals, metal alloys, and any other materials through which air can not pass under typical operating pressures to be encountered by the laminate.

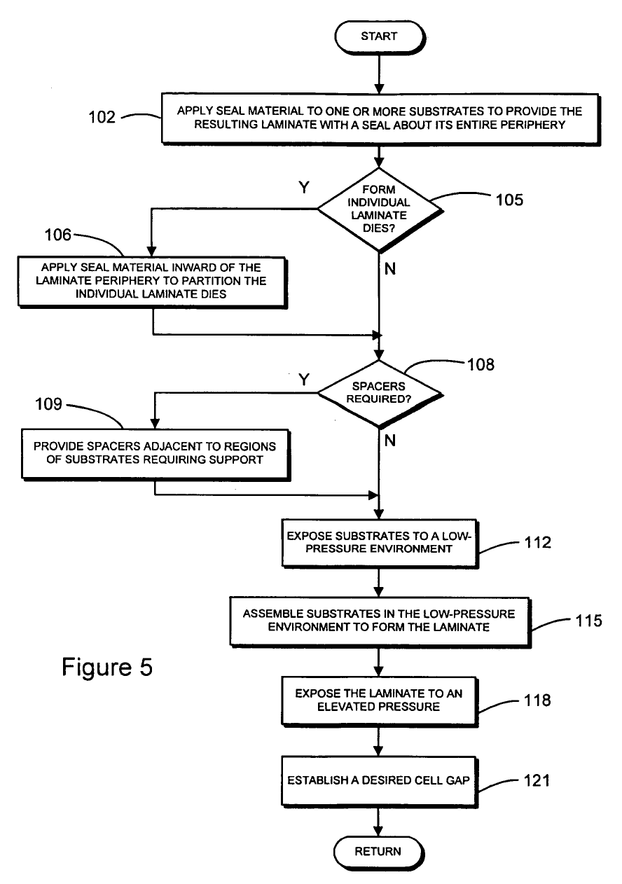

A method of forming a laminate 10 according to an embodiment of the present invention is represented by the flow diagram illustrated in FIG. 5, and includes dispensing or otherwise placing material that will form the seal 18 about the periphery of one or more substrates 12, 15 at step 102, and optionally inward of the periphery of at least one of the substrates 12, 15 at steps 105 and 106. It is worth noting that the order in which the method steps are illustrated in the figures or are described herein do not limit the scope of the claims to that particular order unless specified otherwise. Seal material dispensed or otherwise placed inward of the periphery of one or both substrates 12, 15 can partition the laminate 10 into the individual laminate dies 28 so that when the laminate 10 is diced each individual laminate die 28 is sealed about its periphery. One or more spacers can optionally be provided at step 108 to support central portions of the laminate 10 to prevent the substrates 12, 15 from bowing inward from a vacuum between the substrates 12, 15. Providing the sealant material and optionally the spacers can be performed within a vacuum chamber (not shown) with a controllable ambient pressure, or can be performed before placement of the substrates in the vacuum chamber occurs.

According to an embodiment of a method according to the present invention represented by the flow diagram of FIG. 5, the seal 18 material and optionally the spacers are applied to at least one substrate, and both substrates are placed separately (i.e., apart from each other) into a vacuum chamber. Before assembly of the substrates 12, 15 occurs, the pressure within the vacuum chamber is reduced to a sub-atmospheric pressure at step 112. Once the ambient pressure within the vacuum chamber has reached a suitably-low pressure to achieve the desired cell gap d, the substrates 12, 15 are coupled together at step 115 on opposite sides of the seal 18, thereby defining the cavity 22 between the two substrates 12, 15. After the substrates 12, 15 have been combined to form the laminate 10, the ambient pressure within the vacuum chamber is returned to atmospheric pressure, or a pressure that is greater than the pressure at which the substrates were combined, at step 118. The difference between atmospheric pressure and the pressure within the cavity 27 causes the substrates 12, 15 to be drawn together without the aid of a mechanical press, and without an aperture in the seal 18 through which the atmosphere within the cavity 27 can be evacuated.

The desired cell gap d can be established by controlling the pressure within the cavity 22 relative to the pressure that the laminate 10 is returned to following the combination of the substrates 12, 15 to the seal 18. For instance, increasing this relative pressure difference will impart a stronger force drawing the substrates 12, 15 together than would occur as a result of a lesser pressure difference.

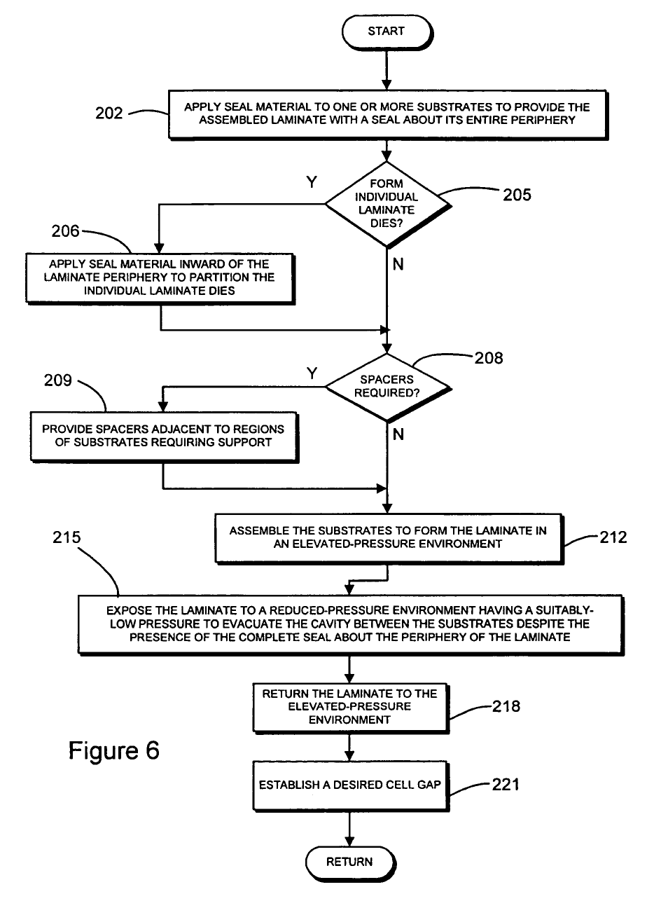

According to the another embodiment illustrated generally in FIG. 6, the seal 18 material, and optionally the spacers, can once again be dispersed or otherwise provided as desired around the periphery of at least one substrate, and inward of the periphery of at least one substrate if desired at steps 202 and 204. Regardless of how the sealant and any spacers are provided to one or both substrates 12, 15, the substrates 12, 15 are coupled together at step 205 on opposite sides of the seal 18, thereby defining the cavity 27 between the two substrates 12, 15. The coupling of the substrates 12, 15 to opposite sides of the seal 18 occurs at atmospheric pressure according to this embodiment, either within the vacuum chamber or before the assembled laminate 10 is placed within the vacuum chamber. Atmospheric pressure is merely used to describe the present invention in detail. The assembly of the substrates 12, 15 on opposite sides of the seal 18 can also occur in an environment having a pressure other than atmospheric pressure, such as the ambient pressure of the intended environment of use, or other suitable pressure that is greater than the pressure to be established between the substrates 12, 15 within the vacuum chamber.

After the substrates 12, 15 have been coupled to opposite sides of the seal 18 to form the laminate 10, the laminate is placed within the vacuum chamber at step 208 (if not already therein) and the pressure within the vacuum chamber is reduced at step 212 to a sub-atmospheric-pressure (or other pressure lower than the pressure at which the substrates 12, 15 were assembled on opposite sides of the seal 18) that is suitable to achieve the desired cell gap. The reduced pressure of this embodiment must be suitable to evacuate the cavity 27 between the substrates 12, 15 through the seal 18 at step 215 without requiring the formation of an aperture in the seal 18 dedicated to allowing evacuation of the cavity 22 to create the vacuum that will draw the substrates 12, 15 together.

The reduced pressure within the vacuum chamber according to the embodiment in FIG. 6 is strong enough to force evacuation of the atmosphere within the cavity 27 either through the seal 18 material itself or between the seal 18 material and one or both of the substrates 12, 15. If evacuation is facilitated through the seal 18 material, temporary apertures will form within the sealant material as the atmosphere within the cavity 22 escapes. As the pressure within the cavity 22 is lowered, the substrates 12, 15 are drawn together and a compressive force is imparted on the seal 18 material disposed therebetween. Any temporary apertures formed in the sealant material during evacuation of the cavity 22 are forced closed by the compressive force exerted by the two substrates 12, 15 on the sealant material. Thus, the seal 18 of the present embodiment can have a self-healing quality that permits evacuation of the cavity 27 after the substrates 12, 15 have been assembled and without requiring a preformed aperture to be formed in the seal 18 material through which evacuation of the cavity 22 can occur.

According to an alternate embodiment, evacuation of the cavity 27 can occur between the seal 18 material and one or both of the substrates 12, 15, thereby minimizing the formation of temporary apertures in the seal 18 material itself. However, the seal 18 material adjacent to the substrate 12, 15 where evacuation occurs can deform to create an opening between the seal 18 material and the respective substrate(s) through which evacuation of the cavity 22 can proceed. In such instances, the compressive force exerted by the substrates 12, 15 on the seal 18 material as the substrates 12, 15 are drawn together by the vacuum formed within the cavity 22 once again forces any such deformations to relax, conforming the seal 18 material to the surface of the respective substrate(s) 12, 15 to seal the cavity 22.

Further embodiments include the evacuation of the cavity 27 through both temporary apertures formed in the seal 18 material as well as between the seal 18 material and one or both of the substrates 12, 15. Again, the compressive force exerted by the substrates 12, 15 on the seal 18 material as they are drawn together forces any temporary apertures formed in, and deformations of the seal 18 material to close.

The environment within the vacuum chamber is then returned to atmospheric pressure, or another elevated pressure that is greater than the pressure at which the substrates were combined, at step 218. The difference between atmospheric pressure or the other elevated pressure and the pressure within the cavity 22 causes the substrates 12, 15 to be drawn together without the aid of a mechanical press, and without requiring a preformed aperture in the seal 18 through which the atmosphere within the cavity 22 can be evacuated.

Just as before, the difference between the pressure within the cavity 22 and the atmospheric or other elevated pressure can be controlled to establish a desired cell gap d. Also, if necessary to ensure separation of the two substrates 12, 15, additional seal 18 material or suitable spacers could be positioned between, and inward of the periphery of the two substrates 12, 15.

As with any embodiment of the present invention, additional seal 18 material can optionally be provided between, and inward of the periphery of the two substrates 12, 15 to divide the interior cavity 22 between the two substrates 12, 15 into individual dies 28 that can later be cut from the laminate 10. The additional seal 18 material can be provided to one or both of the substrates 12, 15 to outline the periphery of the individual dies 28. Thus, during dicing of the laminate 10, the individual dies 28 are cut from the laminate 10 along each inward seal 26, thereby forming a periphery seal 18 for each individual die 28.

Since the present invention includes a variety of practical applications, including those related to the fabrication of liquid-crystal displays, a liquid-crystal fluid can optionally be disposed within the cavity 22. For those applications that require a liquid-crystal fluid to be disposed between the two substrates, the liquid-crystal fluid can be injected through the periphery seal 18 following production of the laminate 10. Other embodiments include a liquid-crystal fluid that is inserted through holes formed in one or both of the substrates 12, 15 once the seal 18 and a desired cell gap d are established.

From the above description of the invention, those skilled in the art will perceive improvements, changes and modifications. Such improvements, changes and modifications within the skill of the art are intended to be covered by the appended claims.

What is claimed is:

1. A method of fabricating a laminate structure, the method comprising the steps of:
applying a seal material to at least one of a first substrate and a second substrate;
coupling the first substrate to the second substrate with the seal material disposed between the first and second substrates, thereby forming a cavity between the first and second substrates and a generally continuous and uninterrupted seal about a periphery of the laminate; and
establishing a desired cell gap between the first substrate and the second substrate by creating a low-pressure within the cavity relative to the pressure outside of the cavity to force the first and second substrates together.

2. The method according to claim 1, wherein the step of applying a seal material comprises the steps of applying a continuous bead of the seal material as a viscous fluid about the periphery of at least one of the first and second substrates.

3. The method according to claim 1, wherein the step of coupling the first substrate to the second substrate comprises the steps of:
exposing the first and second substrate to a low-pressure environment; and
coupling the first substrate to the second substrate in the low-pressure environment.

4. The method according to claim 1, wherein the step of creating low-pressure within the cavity comprises the steps of:
exposing the first and second substrates to a low-pressure environment after the first substrate is coupled to the second substrate.

5. The method according to claim 1 further comprising the step of enclosing a liquid-crystal fluid within the cavity.

6. The method according to claim 1 further comprising the step of applying the seal material to one or both of the first and second substrates in a pattern that partitions the laminate structure into individual laminate dies when the first substrate is coupled to the second substrate.

7. A method of fabricating a laminate structure, the method comprising the steps of:
applying a seal material to at least one of a first substrate and a second substrate in a pattern that forms a seal about a periphery of the laminate structure;
exposing the first and second substrates to a low-pressure environment having a lower pressure than an ambient environment to which the laminate structure will be returned following exposure to the low-pressure environment;
coupling the first substrate to the second substrate in the low-pressure environment to form the seal and a cavity between the first and second substrates; and
establishing a desired cell gap by exposing the coupled first and second substrates to the ambient environment having a higher pressure than the low-pressure environment.

8. The method according to claim 7, wherein the higher pressure is atmospheric pressure.

9. The method according to claim 7, wherein the lower pressure is a sub-atmospheric pressure.

10. The method according to claim 7 further comprising the step of enclosing a liquid-crystal fluid within the cavity between the first and second substrates.

11. The method according to claim 7 further comprising the step of providing one or more spacers to at least one of the first and second substrates to minimize contact between the first and second substrates once the first substrate is coupled to the second substrate.

12. The method according to claim 7 further comprising the step of applying the seal material to one or both of the first and second substrates in a pattern that will partition the laminate structure into individual dies when the first substrate is coupled to the second substrate.

13. The method according to claim 7, wherein the step of establishing the desired cell gap comprises the step of:
forcing the first and second substrates together by a pressure difference between a pressure within the cavity and the higher pressure of the ambient environment.

14. A method of fabricating a laminate structure, the method comprising the steps of:
applying a seal material to at least one of a first substrate and a second substrate in a pattern that forms a seal about a periphery of the laminate structure when the first substrate is coupled to the second substrate;
coupling the first substrate to the second substrate on opposite sides of the seal material in an environment having a first pressure, thereby forming the seal and a cavity between the first and second substrates;
exposing the coupled first and second substrates to a low-pressure environment having a second pressure that is lower than the first pressure; and
establishing a desired cell gap by exposing the coupled first and second substrates to an environment having a higher pressure than the pressure in the low-pressure environment following exposure of the substrates to the low-pressure environment.

15. The method according to claim 14 further comprising the step of enclosing a liquid-crystal fluid within the cavity between the first and second substrates.

16. The method according to claim 14, wherein the first pressure is atmospheric pressure and the second pressure is a sub-atmospheric pressure.

17. The method according to claim 14 further comprising the step of providing one or more spacers to at least one of the first and second substrates to minimize contact between the first and second substrates once the first substrate is coupled to the second substrate.

18. The method according to claim 14 further comprising the step of applying the seal material to one or both of the first and second substrates in a pattern that will partition the laminate structure into individual laminate dies when the first substrate is coupled to the second substrate.

19. The method according to claim 14, wherein the step of establishing the desired cell gap comprises the step of:
forcing the first and second substrates together due to a pressure difference between a pressure within the cavity and the higher pressure of the ambient environment.

20. A laminate produced according to a method comprising the steps of:
applying seal material about a periphery of a first substrate;
placing the first substrate and a second substrate in a vacuum chamber;
evacuating the vacuum chamber to establish a sub-atmospheric low-pressure environment;
coupling the first substrate to the second substrate on opposite sides of the seal material in the low-pressure environment, thereby forming the seal and a cavity between the first and second substrates; and
establishing a desired cell gap by exposing the coupled first and second substrates to an atmospheric-pressure ambient environment.

21. The laminate structure according to claim 20, wherein the method further comprises the step of enclosing a liquid-crystal fluid within the cavity.

22. The laminate structure according to claim 20, wherein the method further comprises the step of providing one or more spacers to at least one of the first and second substrates to minimize contact between the first and second substrates after the first substrate is coupled to the second substrate.

23. The laminate structure according to claim 20, wherein the method further comprises the step of applying the seal material to the first substrate in a pattern that will partition the laminate structure into individual laminate dies when the first substrate is coupled to the second substrate.

24. A laminate comprising:
a first substrate coupled to a second substrate, wherein the first and second substrates define a cavity having a predetermined cell gap; and
a continuous seal disposed between the substrates that extends about the entire periphery of the laminate and is substantially devoid of apertures formed during fabrication to allow access to the cavity.

25. The laminate according to claim 24, wherein at least one of the first and second substrates is formed from a semiconducting material.

26. The laminate according to claim 24 further comprising a liquid-crystal fluid enclosed within the cavity.

27. The laminate according to claim 24 further comprising one or more spacers disposed within the cavity to minimize physical contact between the first and second substrates.

28. The laminate according to claim 24 further comprising one or more seals located inward from the periphery of the laminate to partition the laminate into a plurality of individual laminate dies.
